(19) United States
(12) Patent Application Publication
(10) Pub. No.: US 2015/0362794 A1
(43) Pub. Date: Dec. 17, 2015

(54) COLOR FILTER SUBSTRATE AND MANUFACTURE METHOD THEREOF, AND DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Libin Pang, Beijing (CN); Xuesong Gao, Beijing (CN)

(21) Appl. No.: 14/473,362

(22) Filed: Aug. 29, 2014

(30) Foreign Application Priority Data
Jun. 11, 2014 (CN) 201410256827.9

(51) Int. Cl. G02F 1/1335; G02B 5/20; G02F 1/1362; G02F 1/1368; G02F 1/1337

(52) U.S. Cl. CPC G02F 1/133514; G02F 1/1368; G02F 1/133707; G02F 1/136204; G02B 5/201; G02F 1/133516; G02F 1/133512

(57) ABSTRACT

This disclosure provides a color filter substrate, comprising a substrate, a color filter layer and a latticed black matrix; wherein the black matrix is disposed on a first surface of the substrate and the color filter layer is disposed on an opposite second surface of the substrate to the first surface; and, the black matrix is made of material having electric conductivity and lightproof property. Also, the disclosure provides a display device comprising the abovementioned color filter substrate. Meanwhile, the disclosure provides a manufacture method for a color filter substrate, the method comprising the following steps of: forming a latticed black matrix on a first surface of a substrate, wherein the black matrix is made of material having electric conductivity and lightproof property; and forming a color filter layer on an opposite second surface of the substrate to the first surface.

### CROSS-REFERENCE TO RELATED APPLICATION

This application claims the benefit of Chinese Patent Application No. 201410256827.9 filed on Jun. 11, 2014 in the State Intellectual Property Office of China, the whole disclosure of which is incorporated herein by reference.

### BACKGROUND OF THE INVENTION

1. Field of the Invention

Embodiments of the present invention relate to the field of display technology, and particularly to a color filter substrate and a manufacture method thereof, and a display device.

2. Description of the Related Art

Liquid crystal display mainly includes an array substrate, a color filter substrate and a liquid crystal molecular layer between the array substrate and the color filter substrate. Specifically, the color filter substrate comprises a substrate, and a color filter layer and a black matrix disposed on one side of the substrate, wherein the black matrix is used for prevent leakage of light while increasing contrast ratio, and, the color filter layer is used for achieving a color displaying.

Moreover, in order to avoid adverse effects on normal displaying of the liquid crystal display by electrostatic, usually, a transparent conductive layer is disposed on the other surface of the substrate. During the displaying, electrostatic can be conducted and thus eliminated by the transparent conductive layer. In this way, it will not adversely affect deflection of the liquid crystal molecules in the liquid crystal molecular layer, thereby ensuring normal displaying of the liquid crystal display.

In the prior arts, however, the black matrix and the transparent conductive layer are respectively disposed on both sides of the substrate and should be manufactured separately, therefore, the color filter substrate encounters a relatively complicated manufacture process and a relatively high manufacture cost.

### SUMMARY OF THE INVENTION

At least one object of the present invention is to provide a color filter substrate which has a simplified configuration.

Another object of the present invention is to provide a color filter substrate, which has a simplified manufacture process.

Still another object of the present invention is to provide a color filter substrate which has a reduced manufacture cost.

Yet another object of the present invention is to provide a manufacture method for a color filter substrate, which has a simplified manufacture process.

Still yet another object of the present invention is to provide a display device including the abovementioned color filter substrate, which has a reduced manufacture cost.

In order to achieve one or more of the above objects, according to one aspect of the present invention, there is provided a color filter substrate, comprising a substrate, a color filter layer and a latticed black matrix; wherein the black matrix is disposed on a first surface of the substrate and the color filter layer is disposed on an opposite second surface of the substrate to the first surface; and, the black matrix is made of material having electric conductivity and lightproof property.

According to another aspect of the present invention, there is provided a display device comprising the abovementioned color filter substrate.

According to still another aspect of the present invention, there is provided a manufacture method for a color filter substrate, the method comprising the following steps of: forming a latticed black matrix on a first surface of a substrate, wherein the black matrix is made of material having electric conductivity and lightproof property; and forming a color filter layer on an opposite second surface of the substrate to the first surface.

### BRIEF DESCRIPTION OF THE DRAWINGS

The above and other features of the present invention will become more apparent by describing in detail exemplary embodiments thereof with reference to the accompanying drawings, in which:

FIG. 1 is a cross sectional view of a color filter substrate according to an exemplary embodiment of the present invention;

FIG. 2 is a schematic view of a first side of the color filter substrate according to the embodiment of the present invention;

FIG. 3 is a schematic view of an opposite second side of the color filter substrate to the first side according to the embodiment of the present invention; and

FIG. 4 is a flow diagram of a manufacture method for a color filter substrate according to an exemplary embodiment of the present invention.

### REFERENCE NUMBERS

1—substrate; 2—black matrix; 3—color filter layer; 4—transparent protective layer; 5—spacer; 51—main spacer; and, 52—secondary spacer.

### DETAILED DESCRIPTION OF THE EMBODIMENTS

Exemplary embodiments of the present invention will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

According to a general concept of the present invention, there is provided a color filter substrate, comprising a substrate, a color filter layer and a latticed black matrix; wherein the black matrix is disposed on a first surface of the substrate and the color filter layer is disposed on an opposite second surface of the substrate to the first surface; and, the black matrix is made of material having electric conductivity and lightproof property. Also, there is provided a display device comprising the abovementioned color filter substrate. Meanwhile, there is provided a manufacture method for a color filter substrate, the method comprising the following steps of: forming a latticed black matrix on a first surface of a substrate, wherein the black matrix is made of material having electric conductivity and lightproof property; and forming a color filter layer on an opposite second surface of the substrate to the first surface.

### First Embodiment

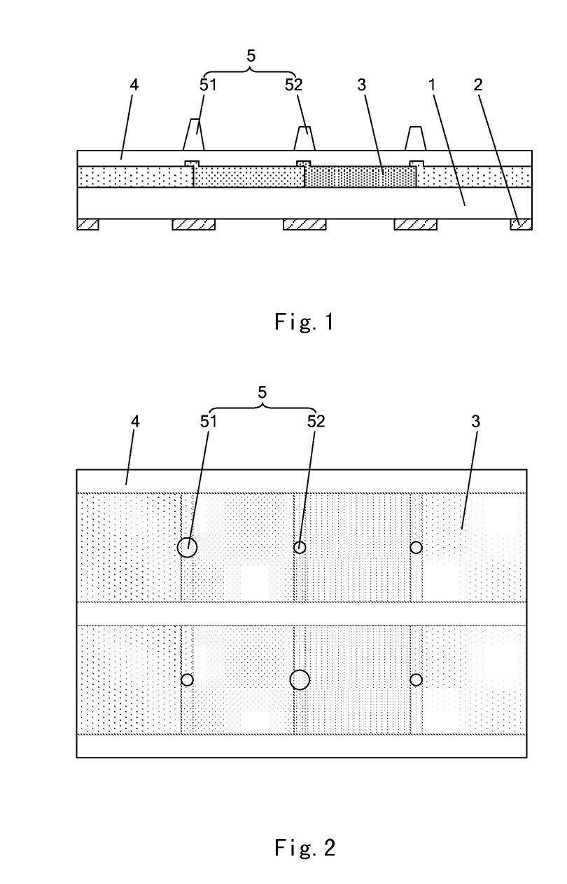

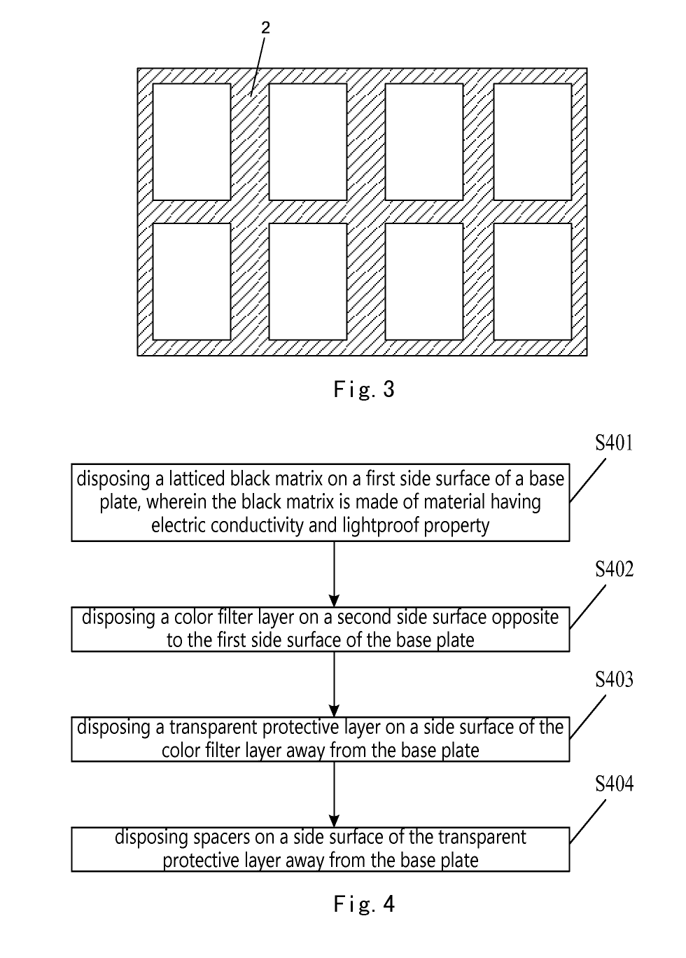

Referring to FIGS. 1-3, there is shown a color filter substrate according to this embodiment of the present invention. The color filter substrate comprises a substrate 1, a color filter layer 3 and a latticed black matrix 2. The black matrix 2 is disposed on a first surface of the substrate 1 and the color filter layer 3 is disposed on an opposite second surface of the substrate 1 to the first surface; and, the black matrix 2 is made of material having electric conductivity and lightproof property.

Specifically, the black matrix 2 is made of material having electric conductivity and lightproof property. Preferably, the black matrix 2 is capable of not only absorbing light but also reflecting light. However, there is no limitation on this according to this embodiment of the present invention. For example, the black matrix 2 is made of metal or alloy. Preferably, the black matrix 2 is made of any one of chromium, chromium alloy, copper, aluminum, and the like.

According to the present invention, since the black matrix 2 is made of material having electric conductivity and lightproof property, it can eliminate electrostatic, prevent leakage of light and increase contrast ratio, thereby ensuring normal displaying of a liquid crystal display using the color filter substrate. Therefore, it is not necessary to produce a transparent conductive layer, such that manufacture process of the color filter substrate is simplified and the manufacture cost is reduced.

According to the present invention, preferably, the color filter layer 3 comprises red regions, green regions and blue regions. Here, the red regions, the green regions and the blue regions are made of corresponding monochrome resin materials, respectively. It should be mentioned that, in the present invention, there are no specific limitation on arrangement of the color filter layer and distribution of the red regions, the green regions and the blue regions in the color filter layer, as long as each sub-pixel defined by the latticed black matrix is completely covered only by one color region while the display pixel consisted of several adjacent sub-pixels can present different colors. In this embodiment of the present invention, in order to prevent leakage of light, any two adjacent regions with different colors have margins overlapped with each other.

Preferably, the color filter substrate further comprises a transparent protective layer 4 disposed on a surface of the color filter layer 3 away from the substrate 1, and spacers 5 disposed on a surface of the transparent protective layer 4 away from the substrate 1. The transparent protective layer 4 not only is used to protect the black matrix 2 and the color filter layer 3, but also functions to increase smoothness of the surface of the color filter substrate. The spacers 5 are used for maintaining a thickness of a liquid crystal cell (not shown) assembled by the color filter substrate and an array substrate (not shown). In this embodiment of the present invention, the spacers 5 further comprise main spacers 51 and secondary spacers 52, wherein the main spacers 51 have a greater height than the secondary spacers 52. After assembled, top parts of the main spacers 51 are in contact with the array substrate while there still are certain gaps between the array substrate and top parts of the secondary spacers 52. In this way, once the liquid crystal cell is compressed by an exterior force, the top parts of the secondary spacers 52 are brought to be in contact with the array substrate, thereby helping maintenance of the thickness of the liquid crystal cell.

Meanwhile, according to this embodiment of the present invention, there is also provided a display device comprising the abovementioned color filter substrate. Such display device can be a product or component having the display function, such as a liquid crystal panel, an electronic paper, an OLED panel, a mobile phone, a tablet PC, a TV, a display, a notebook computer, a digital frame, a navigator, etc.

Exemplarily, the display device can be an Advanced Super Dimension Switch (ADS) Thin Film Transistor Liquid Crystal Display. In the conventional ADS, in the TFT-LCD, both the common electrodes and the pixel electrodes are disposed on the array substrate, and, the common electrodes or the pixel electrodes are in a slit shape or are formed with slits, therefore, liquid crystal molecules deflect under the horizontal electric field introduced by the common electrodes and the pixel electrodes, and in such a case, external electrostatic will adversely affect deflection of the liquid crystal molecules in an even more serious manner. For this purpose, the color filter substrate according to this embodiment of the present invention can be used in the ADS TFT-LCD, in order for effectively achieving electrostatic shielding.

### Second Embodiment

Referring to FIG. 4, there is shown a manufacture method for a color filter substrate according to this embodiment of the present invention. The manufacture method for a color filter substrate comprises:

step 401 of forming a latticed black matrix on a first surface of a substrate, wherein the black matrix is made of material having electric conductivity and lightproof property; and

step 402 of forming a color filter layer on an opposite second surface of the substrate to first surface.

It should be mentioned that, regarding the step of forming the latticed black matrix 2 on the first surface of the substrate 1, different settings will be adopted according to different materials for the black matrix 2. For example, the black matrix 2 is made of metal or alloy. Preferably, the black matrix is made of any one of chromium, chromium alloy, copper, and aluminum. For example, the black matrix 2 made of metal or alloy may be manufactured as follows: first, a layer of metallic film or of alloy film is formed onto the first surface of the substrate 1 by means of sputtering, evaporation, deposition or electroplating process, next, a layer of photoresist is coated onto the layer of metallic film or of alloy film, then a photo mask including a pattern for the black matrix is covered over the layer of photoresist, and finally, the latticed black matrix 2 is formed on the first surface of the substrate 1 after process steps such as exposure, development, etching, peeling off the photoresist and the like.

According to the present invention, preferably, the color filter layer 3 comprises red regions, green regions and blue regions. Here, the red regions, the green regions and the blue regions are made of corresponding monochrome resin materials, respectively. Specifically, the red regions, the green regions and the blue regions are formed respectively in three different steps. Exemplarily, the red regions are firstly formed by coating a layer of red color resin material on the second surface of the substrate 1, covering the layer of red color resin material with a photo mask having a pattern for the red regions, and then performing process steps such as exposure, development, etching and the like. Next, the green regions are formed by firstly, coating a layer of green color resin material on the second surface of the substrate 1, covering the layer of green color resin material with a photo mask having a pattern for the green regions, and then performing process steps such as exposure, development, etching and the like. Finally, the blue regions are formed by firstly coating a layer of blue color resin material on the second surface of the substrate 1, covering the layer of blue color resin material with a photo mask having a pattern for the blue regions, and then performing process steps such as exposure, development, etching and the like. Thereby, the color filter layer 3 is formed on the second surface of the substrate 1. Preferably, in this embodiment of the present invention, in order to prevent leakage of light, any two adjacent regions of the color filter layer 3 with different colors have margins overlapped with each other.

It should be mentioned that, orders for forming the latticed black matrix on the first surface of a substrate and forming the color filter layer on the second surface of the substrate are not limited in the present invention. In this embodiment, for example, firstly, the latticed black matrix 2 is firstly formed on the first surface of a substrate 1, and then the color filter layer 3 is formed on the second surface of the substrate 2. In such a case, the firstly formed black matrix 2 will have positioning function during subsequent manufacture of the color filter layer 3. In other embodiments of the present invention, of course, the color filter layer 3 may firstly formed on the second surface of the substrate 1, and then the latticed black matrix 2 is formed on the first surface of the substrate 1.

Preferably, as shown in FIG. 4, the manufacture method for the color filter substrate may further comprise:

step 403 of forming a transparent protective layer 4 on a surface of the color filter layer 3 away from the substrate 1; and

step 404 of forming spacers 5 on a surface of the transparent protective layer 4 away from the substrate 1.

The transparent protective layer 4 may be preferably formed by a plasma enhanced chemical vapor deposition process.

In an exemplary embodiment, the spacers 5 may be formed by firstly forming a layer of resin material on the transparent protective layer 4, then covering the layer of resin material with a photo mask having a pattern for spacers 5 and finally performing process steps such as exposure, development, etching and the like.

In an exemplary embodiment, the spacers 5 may further comprise main spacers 51 and secondary spacers 52, wherein the main spacers 51 have a greater height than the secondary spacers 52.

In addition, in order to improve displaying effect of the display device including the color filter substrate according to the present invention and to reduce occurrence of adverse effect, in this embodiment of the present invention, after forming the color filter layer 3, the transparent protective layer 4 and the spacer 5, some other steps for repair and supplement may also be performed. In other words, after forming the structure including the color filter layer 3, the transparent protective layer 4 and the spacer 5, a repairing step may be performed when it has been determined that there are some defects in a microcosmic image of the structure. Here, the defects mainly include foreign matters (e.g., dust, fiber, etc.) and missing (e.g., missing of the photoresist), and, the steps for repair and supplement may mainly include grinding (for the foreign matters), inking (for the missing) or the like.

According to this embodiment of the present invention, there is provided a manufacture method for a color filter substrate, the method comprising the following steps of: forming a latticed black matrix on a first surface of a substrate, wherein the black matrix is made of material having electric conductivity and lightproof property; and forming a color filter layer on an opposite second surface of the substrate to the first surface. In this way, the formed black matrix can eliminate electrostatic, prevent leakage of light and increase contrast ratio, thereby ensuring normal displaying of the liquid crystal display. Therefore, it is not necessary to produce the transparent conductive layer, such that manufacture process of the color filter substrate is simplified and the manufacture cost is reduced.

The above embodiments are only used to explain the present invention, and should not be construed to limit the present invention. It will be understood by those skilled in the art that various changes and modifications may be made therein without departing from the spirit of the present invention, the scope of which is defined in the appended claims and their equivalents.

1. A color filter substrate, comprising a substrate, a color filter layer and a latticed black matrix; wherein the black matrix is disposed on a first surface of the substrate and the color filter layer is disposed on an opposite second surface of the substrate to the first surface; and, the black matrix is made of material having electric conductivity and lightproof property.

2. The color filter substrate according to claim 1, wherein the black matrix is made of metal or alloy.

3. The color filter substrate according to claim 2, wherein the black matrix is made of one of chromium, chromium alloy, copper, and aluminum.

4. The color filter substrate according to claim 1, wherein the color filter layer comprises red regions, green regions and blue regions, wherein the color filter layer is configured so that any two adjacent regions of the red regions, the green regions and the blue regions are regions with different colors and have margins overlapped with each other.

5. The color filter substrate according to claim 3, wherein the color filter layer comprises red regions, green regions and blue regions, wherein the color filter layer is configured so that any two adjacent regions of the red regions, the green regions and the blue regions are regions with different colors and have margins overlapped with each other.

6. The color filter substrate according to claim 1, further comprising a transparent protective layer disposed on a surface of the color filter layer away from the substrate, for protecting the black matrix and the color filter layer.

7. The color filter substrate according to claim 5, further comprising a transparent protective layer disposed on a surface of the color filter layer away from the substrate, for protecting the black matrix and the color filter layer.

8. The color filter substrate according to claim 6, further comprising spacers disposed on a surface of the transparent protective layer away from the substrate, for maintaining a thickness of a liquid crystal cell assembled by the color filter substrate and an array substrate.

9. The color filter substrate according to claim 8, wherein the spacers comprise main spacers and secondary spacers, wherein the main spacers have a greater height than the secondary spacers.

10. The color filter substrate according to claim 7, further comprising spacers disposed on a surface of the transparent protective layer away from the substrate, for maintaining a thickness of a liquid crystal cell assembled by the color filter substrate and an array substrate.

11. A display device comprising the color filter substrate according to claim 1.

12. A display device comprising the color filter substrate according to claim 10.

13. A manufacture method for a color filter substrate, the method comprising the following steps of:
forming a latticed black matrix on a first surface of a substrate, wherein the black matrix is made of material having electric conductivity and lightproof property; and
forming a color filter layer on an opposite second surface of the substrate to the first surface.

14. The manufacture method according to claim 13, wherein the black matrix is made of metal or alloy.

15. The manufacture method according to claim 14, wherein the black matrix is made of one of chromium, chromium alloy, copper, and aluminum.

16. The manufacture method according to claim 13, wherein the color filter layer comprises red regions, green regions and blue regions, wherein the color filter layer is configured so that any two adjacent regions of the red regions, the green regions and the blue regions are regions with different colors and have margins overlapped with each other.

17. The manufacture method according to claim 15, wherein the color filter layer comprises red regions, green regions and blue regions, wherein the color filter layer is configured so that any two adjacent regions of the red regions, the green regions and the blue regions are regions with different colors and have margins overlapped with each other.

18. The manufacture method according to claim 13, further comprising a step of:
forming a transparent protective layer on a surface of the color filter layer away from the substrate, for protecting the black matrix and the color filter layer.

19. The manufacture method according to claim 18, further comprising a step of:
forming spacers on a surface of the transparent protective layer away from the substrate, for maintaining a thickness of a liquid crystal cell assembled by the color filter substrate and an array substrate.

20. The color filter substrate according to claim 19, wherein the spacers comprise main spacers and secondary spacers, wherein the main spacers have a greater height than the secondary spacers.
